(19) United States
(12) Patent Application Publication
(10) Pub. No.: US 2020/0283119 A1
(43) Pub. Date: Sep. 10, 2020

(54) Aircraft Door Structure

(71) Applicant: Bell Helicopter Textron Inc., Fort Worth, TX (US)

(72) Inventors: Pier-Alexandre Pelletier, St-Colomban (CA); Guillaume Noiseux-Boucher, Mirabel (CA)

(73) Assignee: Bell Helicopter Textron Inc., Fort Worth, TX (US)

(21) Appl. No.: 16/293,890

(22) Filed: Mar. 6, 2019

(51) Int. Cl. B64C 1/14; E05B 83/40; E05B 85/04; E05B 85/12; E05B 79/12

(52) U.S. Cl. CPC B64C 1/1407; E05B 83/40; E05B 79/12; E05B 85/12; E05B 85/04

(57) ABSTRACT

A door structure and method of assembling same. The door structure includes a door frame delimiting a door opening. The door frame has a latch housing portion defining a latch housing cavity extending along a length of the door frame. A door is mounted to the door frame and displaceable between an open position and a closed position. The door has a peripheral portion with an outer wall and an inner wall delimiting a cavity of the peripheral portion. A door latch assembly has a first latch member fixedly mounted to the door, and a door manipulator mounted to one of the door and the fuselage and coupled to a second latch member within the latch housing cavity of the door frame. The door manipulator is configured to be manipulated to displace the second latch member to engage and disengage the first latch member.

### TECHNICAL FIELD

The application relates generally to doors and, more particularly, to aircraft door structures.

### BACKGROUND

For some conventional doors for aircraft, a door latching system consists of a moveable latching mechanism and a fixed catch. The moveable latching mechanism that is actuated by the user is mounted to the door itself, with the mechanism being integrated inside the door structure. The area surrounding the door has the fixed or immoveable catch of the latching system.

This traditional design means that the structure of the door has to be hollow to allow cables or rods of the moveable latching mechanism to run from the door handle to the latching locations. These passageways need a certain depth/width to allow proper clearance, and may prevent the use of a more compact or weight-efficient structure for the door. Furthermore, the installation of the moveable latching mechanism is complex because it is typically inserted into the door after it has been constructed through multiple access cut-outs in the door that need to be covered over afterwards to eliminate the risk of foreign object damage (FOD) jamming the mechanism.

Furthermore, this conventional design may be more difficult to repair or replace because access to the moveable latching mechanism is restricted through a few small openings in the door.

### SUMMARY

In one aspect, there is provided an aircraft, comprising: a fuselage defining an outer surface and an inner surface, the fuselage having a door frame delimiting a door opening extending through the fuselage and providing access to an interior thereof, the door frame having a latch housing portion defining a latch housing cavity extending along a length of the door frame; a door mounted to the door frame and displaceable between an open position and a closed position, the door having a peripheral portion with an outer wall and an inner wall extending from the outer wall inwardly toward the interior of the fuselage, the outer and inner walls delimiting a cavity of the peripheral portion; and a door latch assembly having a first latch member fixedly mounted to the door, and a door manipulator mounted to one of the door and the fuselage and coupled to a second latch member disposed within the latch housing cavity of the door frame, the door manipulator configured to be manipulated to displace the second latch member to engage and disengage the first latch member.

There is provided a door structure, comprising: a door frame delimiting a door opening, the door frame having a latch housing portion defining a latch housing cavity extending along a length of the door frame; a door mounted to the door frame and displaceable between an open position and a closed position, the door having a peripheral portion with an outer wall and an inner wall delimiting a cavity of the peripheral portion; and a door latch assembly having a first latch member fixedly mounted to the door, and a door manipulator mounted to one of the door and the fuselage and coupled to a second latch member within the latch housing cavity of the door frame, the door manipulator configured to be manipulated to displace the second latch member to engage and disengage the first latch member.

There is provided a method of assembling a door structure, the method comprising: providing a door frame delimiting a door opening and having a latch housing portion defining a latch housing cavity; mounting a door to the door frame, the door having a peripheral portion with an internal cavity; fixedly mounting a first latch member to the door; and displaceably mounting a second latch member within the latch housing cavity of the door frame, the second latch member being displaceable to engage and disengage the first latch member.

### DESCRIPTION OF THE DRAWINGS

Reference is now made to the accompanying figures in which:

FIG. 1 is a schematic side view of a rotorcraft in accordance with an embodiment of the present disclosure;

FIG. 2A is a schematic side view of a door structure of the rotorcraft shown in FIG. 1; and

FIG. 2B is a cross-sectional view of part of the door structure of FIG. 2A, taken along the line IIB-IIB in FIG. 2A.

### DETAILED DESCRIPTION

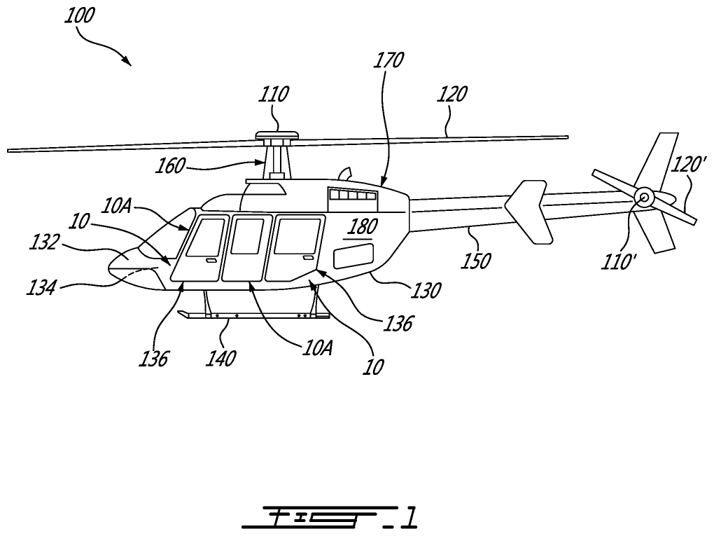

FIG. 1 shows an aircraft. The aircraft shown in FIG. 1A is a rotorcraft 100, according to one example embodiment of the aircraft disclosed herein. The rotorcraft 100 features a rotor system 110, blades 120, a fuselage 130 defining a cabin 180, a landing gear 140, and an empennage 150. The rotor system 110 rotates the blades 120. The rotor system 110 includes a control system for selectively controlling the pitch of each blade 120 in order to selectively control direction, thrust, and lift of the rotorcraft 100. The fuselage 130 represents the body of the rotorcraft 100 and is coupled to rotor system 110 such that the rotor system 110 and the blades 120 may move the fuselage 130 through the air. The landing gear 140 supports the rotorcraft 100 when the rotorcraft 100 is landing and/or when the rotorcraft 100 is at rest on the ground. The empennage 150 represents the tail section of the aircraft and features components of a rotor system 110′ and blades 120′. The blades 120′ may provide thrust in the same direction as the rotation of blades 120 so as to counter the torque effect created by the rotor system 110 and the blades 120. The fuselage 130 defines an outer surface 132 and an inner surface 134. The outer surface 132 is exposed and visible, and forms the outer surface of the body of the rotorcraft 100. The inner surface 134 faces toward the interior of the rotorcraft 100.

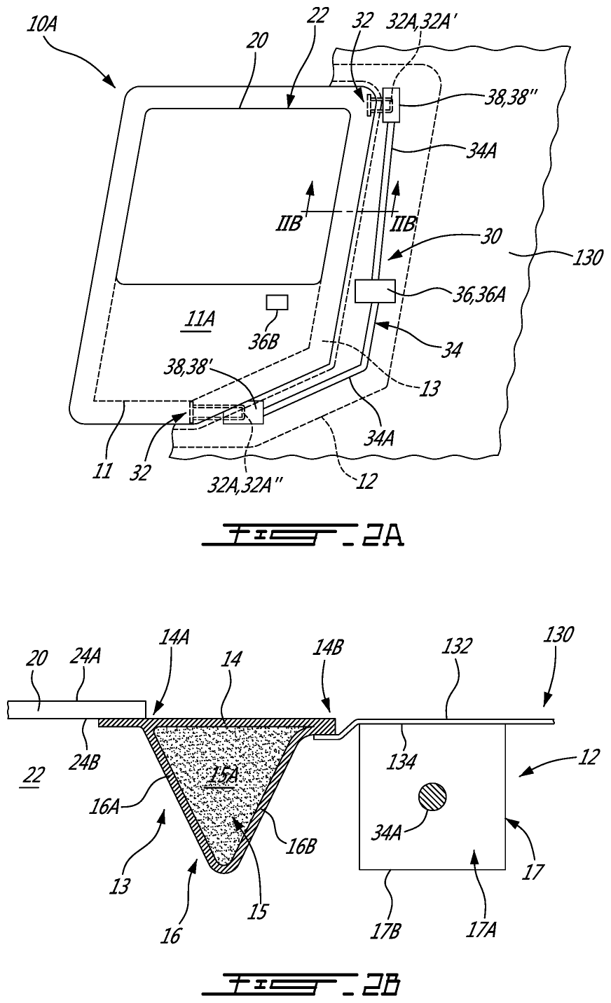

The fuselage 130 has multiple door structures 10 or door assemblies. Each door structure 10 includes a door frame 12 (see FIG. 2A) and a door 10A. The door frame 12 forms the structure to which the door 10A is mounted or fitted. The door frame 12 is the structure which surrounds some or all of the door 10A. In the depicted embodiment, the door frame 12 is a component of, or integral with, the fuselage 130. The door frame 12 delimits a door opening 136 or doorway which extends through the fuselage 130 between the inner and outer surfaces 132,134. The door openings 136 provide access to the interior of the fuselage 130, to the interior of the cabin 180 for example. Each door opening 136 is covered by one of the doors 10A. It will be appreciated that entry into the fuselage 130, and exit from fuselage 130, is achieved through the door openings 136 by opening or closing the corresponding doors 10A.

In FIG. 1, each door 10A is a body which has a window or transparency to admit light. The door 10A is thus a windowed structure. The doors 10A shown in FIG. 1 are passenger doors which open and close to allow passengers to enter and exit the cabin 180 of the rotorcraft 100. Other doors 10A are within the scope of the present disclosure. For example, in an alternate embodiment, the door 10A is a cargo door that admits no light therethrough. In another alternate embodiment, the door 10A is a panel that admits no light therethrough. Therefore, reference to doors 10A herein does not limit the door 10A to being only a light-admitting structure.

Referring to FIGS. 2A and 2B, each door 10A is any suitable moveable part or barrier which is mounted to the door frame 12 about one of the door openings 136 using any suitable structure such as hinges. It will be appreciated that the door 10A may also slide with respect to the door frame 12, and thus may have suitable mounting structure to enable such functionality. Each door 10A is displaceable between an open position to provide access to the interior of the fuselage 130 via the door opening 136, and a closed position (shown in FIG. 2A) to block the door opening 136 and prevent access therethrough.

The rotorcraft 100 also has a door latch assembly 30. The door latch assembly 30 is used to open and close the door 10A, and to latch and unlatch the door 10A to the door frame 12. The door latch assembly 30 thus forms a latching mechanism for the door 10A. When the door 10A is latched, it is in a closed position and is maintained in that position by the door latch assembly 30. When the door 10A is unlatched, it is in an open position. Locks or a locking mechanism can be used with the door 10A and/or the door latch assembly 30 to lock and unlock the door 10A when it is latched. As will be described in greater detail below, some components of the door latch assembly 30 are positioned on or within the door 10A, and other components of the door latch assembly 30 are positioned on or within the door frame 12. The door 10A and door frame 12 have structure, described in greater detail below, some of which may be used to house or position components of the door latch assembly 30.

With respect to the door 10A, and referring to FIG. 2A, the door 10A has a door body 11 with a peripheral portion 13. The peripheral portion 13 of the door 10A is a structural segment of the door 10A that delimits the periphery of the door 10A. The peripheral portion 13 gives structure to the door 10A along its periphery to reinforce the strength and stiffness of the door 10A along its periphery. The door body 11 also has an interior portion 11A positioned inwardly of the peripheral portion 13 and delimited thereby. The peripheral portion 13 in the depicted embodiment extends along all of the periphery of the door body 11. In an alternate embodiment, the peripheral portion 13 extends along less than all of the periphery of the door body 11. The door 10A has a window element 20 in the depicted embodiment which allows light to be admitted through the door 10A. The window element 20 is any suitable transparency or other body to achieve this purpose. The window element 20 may have any suitable shape or size, and may be made from any suitable material such as a polymer and glass. In the depicted embodiment, the window element 20 is a single layer of glass. Other configurations for the window element 20 are also possible. The window element 20 covers or occupies a window opening 22 which extends through the interior portion 11A of the door body 11. The window element 20 has an outer window surface 24A which forms the external surface of the window element 20, and an inner window surface 24B (see FIG. 2B). In the depicted embodiment, some of the peripheral portion 13A delimits the window opening 22 and the window element 20. In an alternate embodiment, the door 10A is free of a transparency or window element.

FIG. 2B shows the peripheral portion 13 and window element 20 in cross-section and according to one embodiment of the present disclosure. The peripheral portion 13 includes an outer wall 14. The outer wall 14 is the segment of the peripheral portion 13 closest to the outer surface 132 of the fuselage 130. In the depicted embodiment, the outer wall 14 is an outermost wall of the peripheral portion 13. The outer wall 14 extends between a first end 14A, sometimes referred to herein as the “window end 14A”, and a second end 14B, sometimes referred to herein as the “fuselage end 14B”. The second end 14A is the extremity of the outer wall 14 which is closest to a center of the window opening 22, and furthest from the fuselage 130. The fuselage end 14B is the extremity of the outer wall 14 which is closest to the fuselage 130, and furthest from the center of the window opening 22. An inner wall 16 extends from the outer wall 14 inwardly. When the door 10A in the depicted embodiment is in the closed position, the inner wall 16 extends from the outer wall 14 inwardly toward the interior of the fuselage 130. The outer and inner walls 14,16 meet and are bonded or fastened together. The inner wall 16 has a V-shape in the illustrated cross-section. The inner wall 16 includes a first segment 16A and a second segment 16B in the depicted embodiment. The first and second segments 16A,16B of the inner wall 16, and the outer wall 14, are interconnected to form a triangular cross-sectional shape of the peripheral portion 13. The triangular cross-sectional shape of the peripheral portion 13 may or may not be present throughout the entire extent of the peripheral portion 13. The first segment 16A of the inner wall 16 extends inwardly from the outer wall 14 at the second end 14A. The first segment 16A of the inner wall 16 extends inwardly in a direction toward the fuselage 130 from the outer wall 14 at the second end 14A. In other embodiments, the inner wall 16 might have a different shape than the triangular shape depicted in FIG. 2B.

In the embodiment shown in FIG. 2B, the inner wall 16 and the outer wall 14 delimit a cavity 15 of the peripheral portion 13, such that the peripheral portion 13 is hollow along at least part of its length. Stated differently, the cavity 15 may or may not be present throughout the entire extent of the peripheral portion 13. The presence of the cavity 15 results in the door 10A having some depth or thickness at least along the peripheral portion 13. The cavity 15 in FIG. 2B is an internal cavity of the peripheral portion 13 at the cross-section shown, and is closed on all sides by the outer and inner walls 14,16. In some embodiments, some of which are described below, the cavity 15 of the peripheral portion 13 is at least partially filled.

For example, and as shown in FIG. 2B, the cavity 15 is filled or bonded with a stiffener 15A. The stiffener 15A is any object or material which increases the stiffness of the peripheral portion 13, and thus its strength, to reinforce the peripheral portion 13 against out of plane forces. The stiffener 15A may be made of any suitable material, and have any suitable shape or configuration to achieve such functionality. For example, in the depicted embodiment, the stiffener 15A has substantially the same cross-sectional shape as the cavity 15 (i.e. triangular). The stiffener 15A fully occupies the cavity 15, and abuts against the outer and inner walls 14,16 of the peripheral portion 13. In an alternate embodiment, the stiffener 15A occupies less than the entirety of the cavity 15, and/or extends across the cavity 15 between the outer and inner walls 14,16. The stiffener 15A in the depicted embodiment is made from a composite material. The stiffener 15A in the depicted embodiment is a composite foam. The foam may have a relatively low density. Thus, in the depicted embodiment, the cavity 15 in the door 10A is filled with a foam stiffener 15A abutting against the inner and outer walls 16,14 along at least some of the length of the cavity 15. In FIG. 2B, the stiffener 15A is shown in the cavity 15 of the peripheral portion 13 of the door 10A, and it may also be present in other parts of the door 10A.

The cavity 15 may have other shapes as well. In an alternate embodiment, the cavity 15 has a “C” shape in cross-section. In an alternate embodiment, the cavity 15 is partially open, and defined by the inner and outer walls 16,14 forming a “T” shape in cross-section.

As mentioned above, the door frame 12 may have structure used to house or position components of the door latch assembly 30. Referring to FIG. 2B, the door frame 12 has a latch housing portion 17. The latch housing portion 17 is a portion of the door frame 12 which houses some or all of components of the door latch assembly 30. The latch housing portion 17 defines a latch housing cavity 17A which extends along at least some of the length of the door frame 12. The one or more components of the door latch assembly 30 are positioned in the latch housing cavity 17A, and are thus protected by the latch housing portion 17. The latch housing portion 17 may take any suitable configuration to achieve such functionality. For example, in the depicted embodiment, the latch housing portion 17 includes a cover 17B or trim panel. The cover 17B is removably mounted to one of the inner and outer surfaces 134,132 of the fuselage 130. As shown in FIG. 2B, the cover 17B is mounted to the inner surface 134 of the fuselage 130, and projects inwardly from the inner surface 134 toward the cabin 180. The cover 17B is a protector or housing that is bolted or attached to the fuselage 130, and defines the latch housing cavity 17A between itself and the inner surface 134. Thus, in the embodiment where the latch housing portion 17 includes the cover 17B, the removability of the cover 17B makes the components of the door latch assembly 30 easy to access and install because the cover 17B is fitted onto aircraft structure as a “bolt-on” instead of a “build-in”. In contrast to some conventional structures, the latch or latch components are not trapped within the structure of the aircraft, or accessible only thorough small cut-outs in the aircraft structure.

Other configurations for the latch housing portion 17 are possible. In an alternate embodiment, the latch housing portion 17 forms part of the fuselage 130 and the latch housing cavity 17A is an internal cavity located within the fuselage 130. The latch housing portion 17 and the latch housing cavity 17A have vertical orientations in the depicted embodiment, but may also have a different orientation (e.g. horizontal or inclined to both the horizontal and vertical).

Referring to FIGS. 2A and 2B, the door latch assembly 30 is now described in greater detail. The door latch assembly 30 has a first latch member 32 and a second latch member 34. The first and second latch members 32,34 cooperate with one another to latch the door 10A in the open or closed position, and to unlatch the door 10A so that it is free to move relative to the door frame 12.

As shown in FIG. 2A, the first latch member 32 is fixedly mounted to the door 10A. By “fixedly mounted”, it is understood that the first latch member 32 does not displace with respect to the door 10A. The first latch member 32 moves with the door 10A between the open and closed positions. The first latch member 32 may be mounted to the inner or outer surface of the door 10A, it may be positioned within the door 10A or exposed thereon, and may be positioned at any location on the door 10A such as along an edge thereof. A particular configuration of the first latch member 32 is described below, and the present disclosure also includes other configurations of the first latch member 32.

The second latch member 34 is displaceable. The second latch member 34 is displaceable with respect to the door frame 12 to engage with, and disengage from, the first latch member 32. The second latch member 34 is disposed in whole or in part within the latch housing cavity 17A of the door frame 12, and is thus shielded by the latch housing portion 17.

The second latch member 34 is displaced when a person manipulates a door manipulator 36. The door manipulator 36 is any object which is manipulated by a user to open and close the door 10A. The door manipulator 36 is mounted to one or both of the door 10A and the fuselage 130 (e.g. the door frame 12). In FIG. 2A, a portion of the door manipulator 36 is shown mounted to the door frame 12, and another portion is shown mounted to the door 10A, as described in greater detail below. The door manipulator 36 is coupled or mechanically linked to the second latch member 34 such that manipulation of the door manipulator 36 will cause displacement of the second latch member 34. The door manipulator 36, and its coupling to the second latch member 34, may take any suitable form to achieve such functionality.

For example, in FIG. 2A, the door manipulator 36 includes, or is in the form of, a handle 36A mounted to the fuselage 130 in proximity to, on, or over the door frame 12. The handle 36A is installed on the fuselage 130 in an area easily accessible by the occupant. In FIG. 2A, the second latch member 34 includes a cable or rod 34A extending along a height of the door frame 12. The handle 36A is mechanically linked to the rod 34A such that rotation of the handle 36A causes the rod 34A to linearly displace in a direction parallel to its upright or vertical orientation. The door manipulator 36 also includes a switch 36B positioned on the door 10A to be accessible by an occupant. The switch is operatively connected to the handle 36A in any suitable way, such that the switch 36B may be pushed or activated by the occupant to latch and unlatch, and/or lock and unlock, the handle 36A and prevent it from rotating. The switch 36B in the depicted embodiment is accessible only from outside of the fuselage 130, but it may also be positioned to be accessible from within the fuselage 130. In one possible embodiment, the switch 36B is an electro-mechanical component which is electrically coupled to the handle 36A.

Other configurations for the door manipulator 36 and its coupling to the second latch member 34 are possible. In an alternate embodiment, the door manipulator 36 includes, or is in the form of, a knob which is turned to displace a wire or cable of the second latch member 34. In another alternate embodiment, the door manipulator 36 includes, or is in the form of, a button which is pushed to displace the second latch member 34. It will therefore be appreciated that the door manipulator 36, the manner by which it is manipulated, and/or the manner by which it is coupled to the second latch member 34, may vary.

The manipulation of the door manipulator 36 displaces the second latch member 34 within the latch housing portion 17. In FIG. 2A, the displacement of the rod 34A is an axial movement along the longitudinal axis of the rod 34A. At least parts of the rod 34A are displaceable in a direction along a height of the door 10A. Other types of displacement of the second latch member 34 are possible. The second latch member 34 displaces to engage and disengage the first latch member 32, so as to latch and unlatch the door 10A.

Therefore, in FIGS. 2A and 2B, the fixed first latch member 32 is disposed on the door 10A, and the displaceable second latch member 34 is disposed on the structure of the fuselage 130 surrounding and supporting the door 10A, which is the door frame 12 in the depicted embodiment. No components of the door latch assembly 30 are positioned within the cavity 15 of the door 10A. It will thus be appreciated that the moving parts of the door latch assembly 30 are not mounted to or in the door 10A. This configuration of the first and second latch members 32,34 allows for positioning the moveable second latch member 34 on the area surrounding the door 10A (e.g. the door frame 12), which is typically large enough to accommodate the moveable second latch member 34. This configuration of the first and second latch members 32,34 allows for optimization of the stiffness of the door 10A, to minimize the depth or thickness of the door 10A thus providing weight savings and increased cabin space, and to increase the size of the window element 20 of the door 10A to provide improved visibility because the moveable portion of the door latch assembly 30 is not present in the door 10A.

One possible configuration of the first and second latch members 32,34 is now described with reference to FIGS. 2A and 2B. The first latch member 32 includes one or more strikers 32A which are fixedly mounted to the door 10A. In FIG. 2A, the first latch member 32 includes two strikers 32A—an upper striker 32A′ fixedly mounted to an upper end of the door 10A and a lower striker 32A″ fixedly mounted to a lower end of the door 10A. Each striker 32A is any suitable object (e.g. catch, bolt, plate, male portion, etc.) which does not displace with respect to the door 10A, and which is engaged by the moveable second latch member 34. The strikers 32A in FIG. 2A are separate from one another, and free of any mechanical link to one another. In an alternate embodiment, the strikers 32A are horizontally spaced apart for a door 10A that opens vertically by pivoting about a horizontal axis.

Still referring to FIG. 2A, the rod 34A of the second latch member 34 is a rigid elongated body extending between an upper end and a lower end. The rod 34A has one or more latches 38. In FIG. 2A, the rod 34A has two latches 38—a lower latch 38′ at a lower end of the rod 34A and an upper latch 38″ at an upper end of the rod 34A. The latches 38 in the depicted embodiment are “female” components meant to receive the “male” strikers 32A. Other configurations for the latches 38 are possible and within the scope of the present disclosure. When the door manipulator 36 is manipulated by the operator, the rod 34A is displaced so that the lower latch 38′ engages or disengages the lower striker 32A″, and so that the upper latch 38″ engages or disengages the upper striker 32A′. The latches 38 are displaceable between a first position in which the latches 38 are disengaged from the strikers 32A and the door 10A is unlatched, and a second position in which the latches 38 are engaged with the strikers 32A and the door 10A is latched.

Reference is made to U.S. patent application Ser. No. 16/161,921 filed Oct. 16, 2018, the entirety of which is incorporated by reference herein.

Referring to FIGS. 2A and 2B, there is disclosed a method of assembling the door structure 10. The method includes providing the door frame 12, and mounting the door 10A to the door frame 12. The method also includes fixedly mounting the first latch member 32 to the door 10A, and displaceably mounting the second latch member 34 within the latch housing cavity 17A of the door frame 12 so that the second latch member 34 is displaceable to engage and disengage the first latch member 32.

In an embodiment, mounting the door 10A includes forming the door 10A prior to mounting it. Forming the door 10A includes forming the peripheral portion 13 of the door 10A from a single composite laminate delimiting the internal cavity 15. The composite laminate is a product made by bonding together two or more layers of composite material. It is therefore possible to make the peripheral portion 13 of the door 10A, as well as other parts of the door 10A, from a single composite laminate or part, thereby reducing the number of cures required to form the door 10A to a single cure.

Forming the peripheral portion 13 may also include filling the cavity 15 at least partially with the stiffener 15A. The composite foam of the stiffener 15A may be positioned between the layers of the single composite laminate or wrapped by said layers, so that the layers are cured and bonded together around the stiffener 15A in a single, one-step cure. This contrasts with some conventional techniques for making a door which has the moveable components of the latching system. These techniques may involve assembling separate inner and outer composite skins to form the cavity, and fishing the moveable components of the latching mechanism inside the door after the assembly. Such a technique involves two steps, and also requires that multiple cut-out panels be machined in the door to access the moveable components of the latching mechanism inside the door. By helping to eliminate these steps, the forming steps described above help to make the door 10A lighter and more cost-effective to manufacture.

The above description is meant to be exemplary only, and one skilled in the art will recognize that changes may be made to the embodiments described without departing from the scope of the invention disclosed. For example, although described herein as an installed feature of an aircraft, the door structure 10 may be provided as an assembly or grouping of its constituent parts. Still other modifications which fall within the scope of the present invention will be apparent to those skilled in the art, in light of a review of this disclosure, and such modifications are intended to fall within the appended claims.

1. An aircraft, comprising:
a fuselage defining an outer surface and an inner surface, the fuselage having a door frame delimiting a door opening extending through the fuselage and providing access to an interior thereof, the door frame having a latch housing portion defining a latch housing cavity extending along a length of the door frame;
a door mounted to the door frame and displaceable between an open position and a closed position, the door having a peripheral portion with an outer wall and an inner wall extending from the outer wall inwardly toward the interior of the fuselage, the outer and inner walls delimiting a cavity of the peripheral portion; and
a door latch assembly having a first latch member fixedly mounted to the door, and a door manipulator mounted to one of the door and the fuselage and coupled to a second latch member disposed within the latch housing cavity of the door frame, the door manipulator configured to be manipulated to displace the second latch member to engage and disengage the first latch member.

2. The aircraft as defined in claim 1, wherein the cavity delimited by the outer and inner walls of the peripheral portion is at least partially filled with a stiffener.

3. The aircraft as defined in claim 2, wherein the stiffener is a composite foam.

4. The aircraft as defined in claim 1, wherein the latch housing portion includes a cover removably mounted to one of the inner and outer surfaces of the fuselage, the latch housing cavity being defined between the cover and said one of the inner and outer surfaces of the fuselage.

5. The aircraft as defined in claim 1, wherein the door manipulator includes a handle mounted to the fuselage adjacent to the door frame.

6. The aircraft as defined in claim 5, wherein the door manipulator includes a switch positioned on the door and operatively connected to the handle, the switch configured to latch and unlatch the handle.

7. The aircraft as defined in claim 1, wherein the first latch member includes at least one striker fixedly mounted to the door, and the second latch member includes a rod having at least one latch, the door manipulator configured to be manipulated to displace the rod and the at least one latch to engage and disengage the at least on striker.

8. The aircraft as defined in claim 7, wherein the at least one striker includes an upper striker fixedly mounted to an upper end of the door and a lower striker fixedly mounted to a lower end of the door, and the at least one latch has a lower latch at a lower end of the rod and an upper latch at an upper end of the rod.

9. The aircraft as defined in claim 7, wherein the rod is displaceable in a direction along the door.

10. A door structure, comprising:
a door frame delimiting a door opening, the door frame having a latch housing portion defining a latch housing cavity extending along a length of the door frame;
a door mounted to the door frame and displaceable between an open position and a closed position, the door having a peripheral portion with an outer wall and an inner wall delimiting a cavity of the peripheral portion; and
a door latch assembly having a first latch member fixedly mounted to the door, and a door manipulator mounted to one of the door and the fuselage and coupled to a second latch member within the latch housing cavity of the door frame, the door manipulator configured to be manipulated to displace the second latch member to engage and disengage the first latch member.

11. The door structure as defined in claim 10, wherein the cavity delimited by the outer and inner walls of the peripheral portion is at least partially filled with a stiffener.

12. The door structure as defined in claim 11, wherein the stiffener is a composite foam.

13. The door structure as defined in claim 10, wherein the door manipulator includes a handle mounted to the door frame, and a switch positioned on the door and operatively connected to the handle, the switch configured to latch and unlatch the handle.

14. The door structure as defined in claim 10, wherein the first latch member includes at least one striker fixedly mounted to the door, and the second latch member includes a rod having at least one latch, the door manipulator configured to be manipulated to displace the rod and the at least one latch to engage and disengage the at least on striker.

15. A method of assembling a door structure, the method comprising:
providing a door frame delimiting a door opening and having a latch housing portion defining a latch housing cavity;
mounting a door to the door frame, the door having a peripheral portion with an internal cavity;
fixedly mounting a first latch member to the door; and
displaceably mounting a second latch member within the latch housing cavity of the door frame, the second latch member being displaceable to engage and disengage the first latch member.

16. The method as defined in claim 15, wherein mounting the door includes forming the door prior to mounting the door, including forming the peripheral portion of the door from a single composite laminate delimiting the internal cavity.

17. The method as defined in claim 16, wherein forming the peripheral portion of the door includes at least partially filling the internal cavity with a stiffener.

18. The method as defined in claim 15, wherein providing the door frame includes attaching a cover to an exposed surface of the door frame to define the latch housing cavity between the cover and the exposed surface.

19. The method as defined in claim 18, further comprising removing the cover from the exposed surface of the door frame to access the second latch member.

20. The method as defined in claim 15, wherein displaceably mounting the second latch member includes mounting a handle to the door frame and coupling the handle to the second latch member, manipulation of the handle causing the second latch member to displace.
